(19) United States
(12) Patent Application Publication
(10) Pub. No.: US 2010/0037062 A1
(43) Pub. Date: Feb. 11, 2010

(54) SIGNED DIGITAL DOCUMENTS

(76) Inventor: Mark Carney, Sterling, VA (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/538,519

(22) Filed: Aug. 10, 2009

Related U.S. Application Data
(60) Provisional application No. 61/087,838, filed on Aug. 11, 2008.

(51) Int. Cl. H04L 9/32

(52) U.S. Cl. 713/176

(57) ABSTRACT

In one embodiment, a method includes adding data associated with a description of an attribute of a data set to a digital document and generating a digital signature based on the digital document. The data associated with description of the attribute is included in the generating. The data set is not included in the generating. The data set is capable of being included in the digital document. In some embodiments, a data set is a textual string. In some embodiments, an attribute is a pattern such as, for example, a pattern of characters in a textual string.

### CROSS-REFERENCE TO RELATED APPLICATION

This application claims priority to U.S. Provisional Patent Application Ser. No. 61/087,838, filed on Aug. 11, 2008, and entitled “SIGNED DIGITAL DOCUMENTS,” which is incorporated herein by reference in its entirety.

### BACKGROUND

The disclosed embodiments relate generally to signing digital documents including, for example, digital documents describing a web page. Methods and apparatus according to various embodiments are capable of, for example, signing digital documents such that the signed digital documents can be dynamically updated within defined parameters without resigning.

Known methods of protecting or securing web content and other digital documents poorly protect these digital documents from alteration. Often, users of digital documents are taught to trust secured transport mechanisms such as, for example, web sites that use Secure Socket Layer (“SSL”), to protect the transmission of content. However, these mechanisms have no method by which to verify the authenticity of the received digital documents. Such known methods can ensure with a high degree of confidence that a digital document is sent from a particular source (i.e., from a known web server), but fail to ensure or verify that the digital document sent from the source has not been altered or is approved by the author of the digital document.

Some known methods of protecting digital documents include calculating a checksum or signature of a digital document and providing the checksum or signature to a receiver of the digital document. Although such known methods are capable of verifying that the contents of a received digital document have not been altered, these known methods fail to provide for verification of dynamic content. For example, in some known embodiments, a checksum is calculated for the entirety of a digital document. Any alteration of the digital document after the checksum is calculated will result in subsequently calculated checksums for the digital document having values different from the originally calculated checksum. Thus, the contents of the entire digital document can be verified as unaltered, but no part or content of the digital document is dynamic (i.e., for each change to the content of the digital document, a new checksum is generated for verifying the contents).

In other known methods, only a portion of a digital document is verified. For example, in some such known methods, a digital document includes two portions: a verified portion and an unverified portion. The verified portion is verified using, for example, a checksum as described above. The unverified portion is not verified and can be dynamically altered without limitation. Because the unverified portion can be changed without limitation, these known methods lack the ability to determine whether the unverified portion has been altered or if the author approves alterations to the digital document.

Thus, known methods of verifying or signing digital documents fail to provide for verifying the dynamic contents of a digital document. Accordingly, there is a need for improved methods and apparatus for signing digital documents.

### SUMMARY

In one embodiment, a method includes adding data associated with a description of an attribute of a data set to a digital document and generating a digital signature based on the digital document. The data associated with the description of the attribute is included in the generating. At least a portion of the data set is not included in the generating. The data set is capable of being included in the digital document. In some embodiments, a data set is a textual string. In some embodiments, an attribute is a pattern such as, for example, a pattern of characters in a textual string.

In one embodiment, a method includes generating a digital signature based on a digital document, validating the signature and determining whether a data set included in the digital document possesses the attribute. The digital document includes data associated with an attribute potentially possessed by a data set. The data associated with the attribute is included in the generating. At least a portion of the data set is not included in the generating. In some embodiments, the digital document includes the data set and the data set is removed from the digital document before the generating. In some embodiments, an indication of whether the data set possesses the attribute is provided.

### BRIEF DESCRIPTION OF DRAWINGS

FIG. 1 is a flow chart of a process for signing a digital document, according to an embodiment.

FIG. 2 is a flow chart of a process for verifying a signed digital document, according to an embodiment.

FIG. 3 is a system block diagram of a system for sending and receiving a signed digital document, according to an embodiment.

FIG. 4 is a system block diagram of a system for sending and receiving a signed digital document, according to another embodiment.

FIG. 5 is a system block diagram of a system for sending and receiving a signed digital document, according to another embodiment

### DETAILED DESCRIPTION

Methods and apparatus according to various embodiments can be used to sign digital documents such that verification of dynamic content in a digital document is possible. In some embodiments, for example, digital documents including parameters or limitations for unsigned portions are digitally signed and the signatures are embedded within the documents for verification. These signed parameters or limitations can be used to verify the unsigned portions. Such a system would allow users to trust that financial, government and other sensitive web sites with dynamic and/or static content have not been altered while located on a computer server or during transport, are not being “piggybacked” by cross-site-scripting (“XSS”) or other such attacks, and contain content intended and approved by the site's owners/operators.

In one embodiment, a digital hypertext markup language (“HTML”) document is created, signed, verified by a computer server, provided to a computer terminal by the computer server, and verified by the computer terminal. The HTML document is created similarly to a standard HTML document, but additionally includes tags or identifiers specifying a signed portion of the document that will be signed and an unsigned portion that will not be signed.

The signed portion of the document includes a description of one or more attributes of a data set allowed, disallowed or required in the unsigned portion. For example, the unsigned portion can describe a portion of a web page that is dynamically updated with a current score of a baseball game. The attribute described (or defined or included) in the signed portion of the document indicates that only numbers are permissible or approved in the unsigned portion. In another embodiment, the unsigned portion can be the latest news from some source such as, for example, a computer server, a database, a file or other data repository. In such an embodiment, the attribute of the unsigned portion described (or specified) in the signed portion is that the unsigned portion contains only alphanumeric and punctuation characters. Thus, the author of or other person or entity signing or preparing a digital document can specify limitations on an unsigned or dynamic portion of a digital document.

The HTML document is signed by calculating a checksum or hash value (i.e., a value calculated from contents of the HTML document) of the signed portion of the document, encrypting the checksum using the private key of a public/private key pair, and including the encrypted checksum as a signature in the HTML document. The checksum does not include the unsigned portion. In other words, the unsigned portion is excluded from the checksum calculation. Thus, changes to the unsigned portion do not result in a change to the checksum. However, unauthorized alteration of the unsigned portion will result in the unsigned portion lacking the specified attributes. Furthermore, changes to the attributes will result in a change to the checksum because the attributes of the unsigned portion are included in the signed portion and, therefore, signed. After the HTML document is signed, it is placed on a computer server such that a user of a computer terminal can access the HTML document as a web page through the computer server.

When a computer terminal requests access to the HTML document (i.e., requests a web page from the computer server via the Internet), the computer server optionally verifies the document. For example, the computer server can calculate a checksum of the signed portion of the document and verify the calculated checksum using the public key associated with the private key used to sign the digital document and the signature included in the digital document. If the calculated checksum is verified (e.g., is identical to or within some predetermined tolerance of the checksum calculated during signing), the computer server verifies that the unsigned portion of the document has the attributes described in the signed portion. If the unsigned portion has the specified attributes, the computer server provides the document to the computer terminal.

The computer terminal receives the HTML document (or, web page) from the computer server and can verify the document. For example, the computer terminal can calculate a checksum of the signed portion of the document and compare the calculated checksum and signature using the public key associated with the private key used in the signing. If the calculated checksum is verified (e.g., is identical to or within some predetermined tolerance of the checksum calculated during signing), the computer terminal then verifies that the unsigned portion of the document has the attributes described in the signed portion. If the unsigned portion has the specified attributes, the computer terminal displays the HTML document (or, web page) to a user of the computer terminal in, for example, a web browser.

As used in this specification, the singular forms “a,” “an” and “the” include plural referents unless the context clearly dictates otherwise. Thus, for example, the term “a computer server” is intended to mean a single computer server or a combination of computer servers, “a signature” is intended to mean one or more signatures, or a combination thereof.

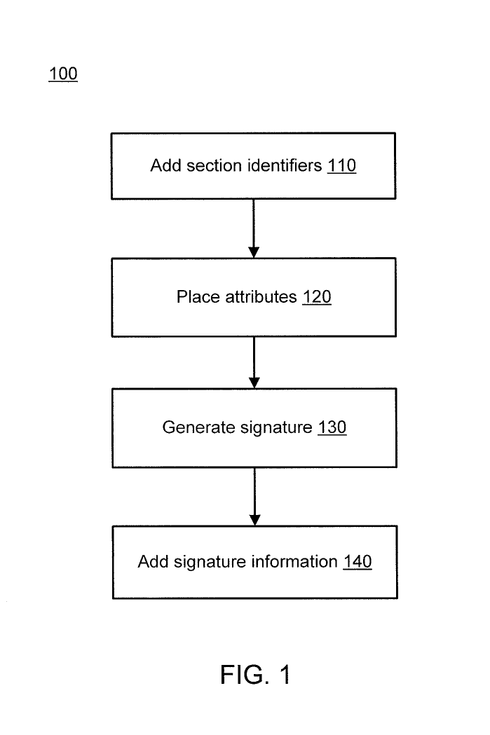

FIG. 1 is a flow chart of process 100 for signing a digital document, according to an embodiment. A digital document can be any document represented in digital form, for example, a text document, a script file, a binary file, a markup language document. In some embodiments, the format of a digital document provides support for section identifiers such as tags or metadata within the digital document. As illustrated in FIG. 1, process 100 includes adding section identifiers 110, placing attributes 120, generating a signature 130 and recording signature information 140.

At 110, section identifiers are added to a digital document. Section identifiers identify various portions of a digital document. Section identifiers can indicate various portions or sections in a digital document including, for example: a portion or portions of a digital document are signed; a portion or portions of a digital document are not signed; a portion or portions of a digital document are pre-signed and independently include verification information (e.g., signature, section identifiers and/or attributes); a portion or portions of a digital document including information or data about a digital document signature; a portion of a digital document including cryptographic information; and/or a portion of a digital document specifying an attribute of a data set to be included in the digital document.

In some embodiments, pre-signed portions are part of and/or included in a digital document when the digital document is signed. A pre-signed portion of a digital document can be a data set such as, for example, a textual string or a file that is signed (e.g., associated with a digital signature and/or a description of attributes of that data set) independent of the digital document. In some embodiments, pre-signed portions of a digital document are inserted at a time after the signing. Additionally, in some embodiments, pre-signed content can be sourced from other computer servers, files, databases and other data repositories.

In some embodiments, section identifiers are tags such as, for example, HTML-style tags disposed throughout a digital document where the position of the tags in the digital document correspond to the section identified. In some embodiments, the section identifiers are disposed in predefined portion of the digital document such as, for example, in a header of a digital document, rather than disposed throughout the digital document. In some embodiments, section identifiers are defined in a separate document named explicitly or by convention. For example, the separate document can be identified in the digital document by some identifier such as a name or location, or can have an identifier similar to an identifier of the digital document. In some embodiments, for example, the separate document has a file name identical to a file name of the digital document, but has a different file extension. In some embodiments, the separate document can include unique strings, offsets or value sequences to identify section identifiers within the digital document. In some embodiments, section identifiers can be included in comments in digital documents such as, for example, scripts with a format supporting comments.

In some embodiments, the section identifiers describe how a section or portion of a digital document will be handled, processed or used in a digital document signing and/or verification process. For example, a section identifier for an unsigned portion of a digital document can also include information about how a data set in the unsigned portion of the digital document will be processed during a signing process. For example, a section identifier can include data specifying whether an unsigned portion of a digital document should be filled or replaced with a default value or string during signing. In some embodiments, the section identifier can specify that a data set in the unsigned portion of the digital document must have a particular attribute. In some embodiments, the section identifier itself has meaning in signing and verifying a digital document. For example, a section identifier for a pre-signed portion of a digital document can implicitly indicate that the pre-signed portion of the digital document is not used in the signing process.

In other embodiments, a section identifier can indicate one or more actions that should be taken if a digital document cannot be verified. Such actions can include, for example, indicating to a user that the digital document could not be verified, displaying default content specified in the digital document, reporting the failed verification and associated information (e.g., time, identifier associated with the source of the digital document, portion of the digital document failing verification), and/or requesting the digital document from another source.

Attributes (or descriptions of attributes) of allowed or acceptable data sets are added to the digital document at 120. An attribute can describe content allowed or approved for a digital document, and/or content presently in a digital document. In other words, an attribute or description of an attribute can describe a data set or a representation of a data set such as, for example, an image, video, binary, or other file. In some embodiments, attributes describe a property such as a pattern in a textual string. In some embodiments, the attribute is a file type identifier or extension (e.g., data or metadata describing a type or class of a file), a maximum or minimum size of a file or length of a data set, a resolution or size of an image or video, an encoding method of an image and/or video, and/or a source of data in the digital document. In some embodiments, an attribute is a number of lines of text, number of characters, and/or number of bytes in a portion of a digital document. In some embodiments, an attribute is one or more sets or groups of permissible values or symbols and/or impermissible or forbidden values or symbols.

In some embodiments, an attribute is a location (or a description of a location including a uniform resource identifier (“URI”) such as a uniform resource locator (“URL”)) of a description of a data set or representation of a data set. Furthermore, an attribute can be a URI defining or specifying a location (e.g., computer server accessible via the Internet) at which an attribute (or attribute description) is available or accessible. For example, a commonly used, lengthy attribute description can be accessible as a file at a computer server at a location referenced by an attribute (or attribute description) in a digital document. Thus, the lengthy attribute description can be stored separately from the digital document and referenced (or linked to) by the digital document. Advantageously, such an attribute description can be referenced by multiple digital documents such that the attribute description can be updated or modified once and the updated attribute description is referenced by each of the multiple digital documents.

In some embodiments, a checksum or signature of another digital document such as, for example, an image, audio and/or video file that does not support embedded data or comments is an attribute. In other words, a hash value calculated based on a data set can be an attribute associated with a portion of the digital document that can include that data set. In some embodiments, an attribute can be an image, video and/or audio processing algorithm or input to such an algorithm that can edit content in image, video and/or audio files included or referenced in a digital document. A verification process can use such attributes to ensure that data in a digital document is within acceptable or allowed parameters. For example, a verification process can verify that a digital document and/or a data set included in a digital document has one or more specified attributes.

In some embodiments, the attributes are a combination of attributes. In some embodiments, a single attribute keyword or label can indicate that multiple attributes or an attribute set should be satisfied. For example, an attribute label of “CHILDREN” can indicate that a predefined set of attributes such as, for example, attributes limiting words, image and video content, and the source of linked or referenced content is to be applied to an unsigned portion of a digital document.

In some embodiments, attributes can be specified by a client or user. For example, a web browser receiving a digital document can store attributes, which are applied to portions of a digital document. For example, a web browser can allow for parental or filtering controls that provide attributes configured to prevent profanity or explicit words in the text of unsigned or other portions of a document from being displayed to a user. Said differently, attributes (or descriptions of attributes) can be overridden, modified, and/or given special meaning by a software module such as an application program or by a hardware module.

In some embodiments, attributes can specify one or more parties or entities permitted to add content to the digital document. An attribute can specify a domain or web site from which content such as, for example, pre-signed, text, image, audio, and/or video content can be sourced. For example, an internet service provider (“ISP”) can insert a hyperlink providing an in-line link to an advertisement into an HTML digital document. The hyperlink will fail the verification process if it does not link to the domain specified in the attribute. Thus, attributes can limit the sources of content inserted into a digital document, and allow the creator or signer of a digital document to share in advertising revenue from advertisers by limiting the sources of advertisements in a digital document.

In some embodiments, one or more attributes are associated with one or more portions of a digital document. In some embodiments, one or more attributes are globally associated with a digital document (i.e., an entire digital document has an attribute). Attributes can be included in section identifiers or comments, disposed in a predetermined portion of a document such as a header, and/or specified as discrete identifiers such as, for example, specialized tags in an HTML-style document or elements in an extensible markup language (“XML”) document.

In some embodiments, attributes can describe other documents. For example, attributes can describe documents referenced or linked from a digital document. Such embodiments can provide a way to verify that the referenced document has not been altered or replaced. Verification is possible even in cases where altering the referenced document is undesirable or not possible such as, for example, a file on an external web site linked for download. In some embodiments, an attribute can provide signatures of downloadable files. For example, an attribute can be a signature such as, for example, a hash or checksum for one or more downloadable files referenced (e.g., linked to) in a digital document. Such embodiments can allow a client to verify the signature, checksum or hash and downloadable file based on the verified or validated digital document.

In some embodiments, attributes are included in section identifiers and can be implicitly associated with the portions of a digital document indicated or identified in the section identifiers. For example, an attribute (or description of an attribute) can be one or more comments or data sets in a binary file such as ICMT entries in audio video interleave (“AVI”) files. Additionally, an attribute can be included in a note chunk of a waveform audio format (“WAV”) file. Similarly, in some embodiments, attributes disposed in various portions of a digital document can be implicitly associated with portions of the document. For example, the first attribute encountered in a header of a digital document can be associated with a first content portion of the document; the second attribute in the header can be associated with a second content portion of the document, etc. Furthermore, a single attribute can be applicable to multiple sections or portions of a digital document. Such an attribute can be referred to, for example, as a meta-attribute. For example, the first ICMT entry in an AVI file can specify a default processing unit size (e.g., a number of bytes) that is applicable to each subsequent attribute. In other words, the AVI file can include an initial ICMT entry with an attribute that specifies that each subsequent attribute will be applied to a particular number of bytes, rather than specifying the number of bytes in each ICMT entry in the AVI file.

In some embodiments, attributes disposed in various portions of a digital document can be explicitly associated with portions of the digital document by, for example, including a field in a section identifier indicating an attribute associated with that section, or including a field in an attribute identifier indicating an associated portion of a document. In one embodiment, an HTML document includes an attribute identifier such as an attribute tag, and the attribute tag includes a field for indicating a section identifier to which the attribute described in the attribute tag applies. In another embodiment, an attribute can be an XML element or an XML attribute of an XML element in an XML document.

A signature of the digital document is generated at 130. A signature of a digital document can be any data that represents the digital document. For example, a signature can be a checksum, a count of one of more characters (i.e., a number of times a particular character or characters occurs in a digital document), a character or characters at one or more predetermined positions within a digital document, a hash of the digital document, or other data representative of a digital document and/or the contents of a digital document. In some embodiments, the signature is unique or substantially unique to a particular digital document.

Section identifiers can be used during the generating of the signature. As discussed above, section identifiers can describe how a portion of a digital document should be processed. One or more section identifiers can indicate which portions of a digital document will be included in the signature. For example, section identifiers for unsigned portions and/or pre-signed portions of a digital document can be excluded from the generating a signature based on the section identifiers for these sections. In some embodiments, section identifiers can describe an algorithm for generating a signature of a digital document. For example, section identifiers can indicate which portions of the digital document are included in a signature, or a section identifier can include a name of a hash algorithm for generating the signature.

In some embodiments, the signature can be encrypted or otherwise cryptographically protected or assured as part of generating the signature. For example, a signature can be generated by calculating a checksum of a digital document excluding unsigned portions and pre-signed portions of the digital document and encrypting the checksum with the private key of a public/private key pair. In some embodiments, a symmetric encryption or a digital certificate is used to encrypt data for a signature.

Signature information is added to the digital document at 140. Signature information can include a signature, specification of an algorithm, a key for decrypting or verifying a signature, a reference to or location of a key for decrypting a signature, a section identifier for indicating the portion of a digital document that contains a signature, a key for decrypting or verifying a signature and/or other signature-related information. A key for decrypting or verifying a digital document can be, for example, a public key of a public/private key encryption, a key for a symmetric encryption or a digital certificate. A reference to or location of a key for decrypting a digital document can be a URI such as a URL. The reference to or location of a key can be used to retrieve a key from a network resource such as a key or certificate repository. In some embodiments, the reference to or location of a key can be a reference to a file accessible via a communications network such as, for example, via a network file system. In some embodiments, a key for decrypting or verifying a signature can be stored locally by a user or client or on a local network.

In some embodiments, a signature and/or a cryptographic key or certificate is stored in a separate digital document such as, for example, a signature file or a certificate file. Such files can be made accessible with the digital document (e.g., within a common directory of a network device such as a file transfer protocol (“FTP”) server or HTTP server). In some embodiments, such files can be available separately such as, for example, via a separate FTP server or HTTP server or via a separate, secure communications network. In some embodiments, a reference to or location of the signature file and or certificate file is included in the digital document. In some embodiments, a signature file and/or certificate file can be implicitly associated with a digital document. For example, similar file identifiers, such as file names or portions of file names, can be used to associate a digital document with a certificate file, encryption key file and/or signature file. In some such embodiments, signature information is not explicitly included in the digital document. In some embodiments, metadata, comments and/or file headers can include information for associating a digital document with a signature file and/or a certificate file.

In some embodiments, process 100 can include more or fewer steps than illustrated in FIG. 1. In some embodiments, some steps may occur in a different order, for example, to account for added steps, pre- or post-processing, etc. For example, in some embodiments, validity of an encryption key or certificate can be verified prior to generating or encrypting a signature. A database or list of valid and/or invalid keys or certificates such as, for example, a certificate revocation lists (“CRL”) can be accessed to determine whether a key or certificate is valid. In some embodiments, a pre-signed portion of a digital document or contents disposed within a pre-signed portion of a digital document can be verified as part of a signing process. In some embodiments, a digital signature can include a description of an attribute.

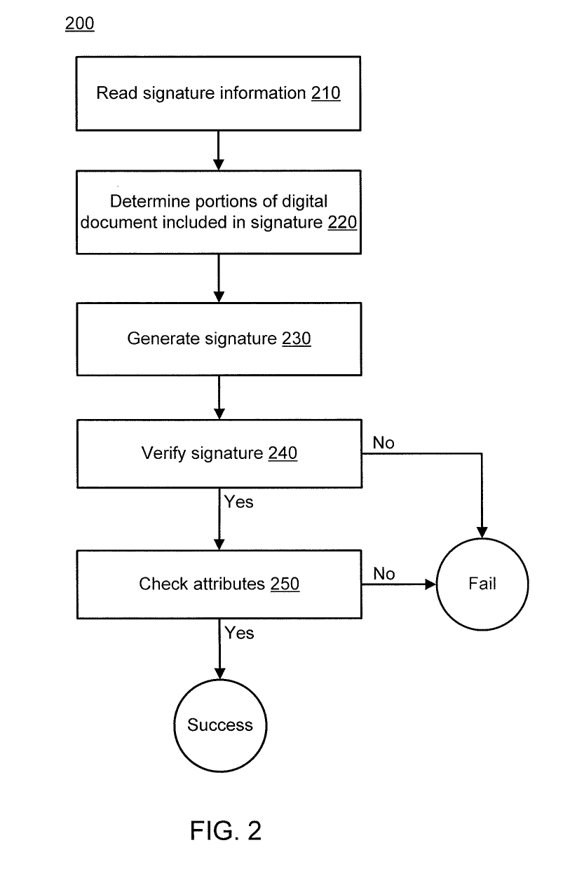

FIG. 2 is a flow chart of process 200 for verifying a signed digital document, according to an embodiment. A digital document can be verified by, for example, validating a signature of a signed portion of the digital document and verifying that a data set included in an unsigned portion of the digital document has an attribute described in a signed portion of the digital document. Section identifiers in a digital document can be used to determine which portions of the digital document include data associated with each step of process 200.

Signature information is read from the digital document at 210. Signature information can include the signature information added to a digital document as described above in relation to FIG. 1. In some embodiments, signature information is accessed from a signature file and/or a certificate file. In some embodiments, signature information is encrypted during signing of the digital document and is decrypted during reading the signature information.

At 220, it is determined which portions of the digital document were included in generating the signature of the digital document. Section identifiers can indicate, as discussed above, the portions of the document that were included in generating the signature. For example, in some embodiments, unsigned portions and/or pre-signed portions of a digital document are not included in generating a signature of a digital document.

A signature of the digital document is generated at 230. As discussed above, a signature of a digital document can be generated based on a variety or algorithms and methodologies, and can include some or all portions of a digital document. For example, a signature can be generated by calculating a checksum of a digital document after excluding unsigned and/or pre-signed portions of the digital document, or producing a hash based on the digital document.

After the signature (e.g., checksum, hash, etc.) is generated at 230, the signature is verified or validated at 240. The signature can be verified or validated by comparing the signature information read at 210 with the signature generated at 230. If the signature matches a predetermined portion of the signature information (i.e., is identical to or within some acceptable tolerance of the signature generated during signing), the signature is validated. In some embodiments, the signature information read at 210 is decrypted prior to comparing it with the signature generated at 230. In some embodiments, the signature generated at 230 is encrypted for comparison with encrypted signature information read at 210.

In some embodiments, the signature generated at 230 is sent to another party for comparing or validating it with the signature information read at 210. For example, a party with access to an encryption and/or decryption key can receive the signature information read at 210 and the signature generated at 230 and encrypt the signature or decrypt the signature information for comparison. The party can then provide an indication of whether the signature generated at 230 was validated.

A validated signature is an indication that the portions of the digital document included in the signature are unaltered from the time the signature information read at 210 was added to the digital document. In some embodiments, a signature is uniquely associated with the data in a digital document such that any change to the data in the digital document will result in a different signature, or—said differently—failure to validate the signature. In some embodiments, a signature is statistically or probabilistically unique to the data in a signed portion of a digital document such that there is a very high probability (e.g., near unity) that any change to the data in the signed portion of the digital document will result in a different signature, or—said differently—failure to validate the signature.

More specifically, a validated signature indicates that the signed portions of the document—including the specified attributes of unsigned portions of the digital document—are unaltered. Thus, if a signature is validated, the unsigned portions of the digital document are checked for the attributes described or specified in the digital document at 250. As discussed above, attributes can be any of a variety of properties and/or limitations of a data set. If the data set in the unsigned portion of the digital document has the attributes (e.g., properties or limitations specified by the attributes), the attributes are satisfied or met and the digital document is verified. If the data set does not have the specified attribute or attributes, the digital document is fails verification.

In one embodiment, an unsigned portion of a digital document includes a text string and the attribute associated with the unsigned portion specifies that each letter in the text string must be lowercase. If each letter is lowercase, the attribute is satisfied and the data set is acceptable. However, if any letter is uppercase, the attribute is not satisfied and the data set is not acceptable. In some embodiments, a client can use attributes from a signed digital document to validate or verify another digital document based on the attribute. For example, an attribute within a first digital document can be a file signature, checksum or hash of a second digital document that is attached to, included within, referenced from, or linked from the first digital document. A client (e.g., a software module such as an application program) can compare the file signature, hash, or checksum included in the first digital document with a signature, hash, or checksum generated based on the second digital document. This can create a higher degree of confidence that files available for download are legitimate or approved by the signer of the digital document.

In some embodiments, as illustrated in FIG. 2, process 200 fails if the signature cannot be validated or an attribute is not satisfied or acceptable. Furthermore, process 200 can include more or fewer steps than illustrated in FIG. 2. For example, an encryption key or certificate can be checked for validity using, for example, a CRL. In some embodiments, process 200 includes validating pre-signed portions of the digital document. In some embodiments, default or alternative content or data is substituted for pre-signed portions or unsigned portions of a digital document that do not have the specified associated attributes. In some embodiments, a digital document can include data, for example, in a section identifier for the entire document indicating an alternate source for the digital document, signature and/or encryption key or certificate for use if a signature cannot be validated. Steps may also be performed in a different sequence. For example, the signature information may not be read until immediately prior to the attempt to verify the signature information.

In some embodiments, a digital document is an HTML document. Additional tags are added as section identifiers to the document to indicate which portions of the document are signed and which are unsigned, and the HTML document is signed as described above. For example, tags added by a web site administrator to an HTML template document indicate unsigned portions and/or pre-signed portions of the document and attributes that describe which content can be included in each portion.

For example, the unsigned portions can be fields for text to be displayed as part of a web page and the attributes can be text patterns that prevent text strings including profanity. In some embodiments, the attributes can be text patterns of an approved date format in a date field, or text patterns excluding vulgar words or phrases from text fields. In some embodiments, the attributes are maximum file sizes and/or image resolutions. Examples of attributes associated with the pre-signed portions include maximum file sizes, display size limitations, file types and/or sources of content.

The HTML document is then signed by removing the unsigned portions and any pre-signed portion, and generating a checksum of the remaining portions of the digital document. For example, a copy of the digital document can be created in a memory of a computer and the unsigned portions and pre-signed portions removed from the copy. The computer then generates a signature using, for example, a cyclic redundancy check (“CRC”) of the remaining portions of the HTML document. The checksum is encrypted based on, for example, a public/private key encryption. In another embodiment, a digital certificate such as an X.509 certificate is used to generate the signature. The encrypted signature (i.e., encrypted checksum or result of the digital certificate signing) is added to the HTML document with a tag identifying the encrypted signature and a public key for decrypting the signature.

Web page authors can fill in or complete the signed HTML template document to create web pages for the web site based on the templates. Prior to posting the web pages on the web site, the web site administrator (e.g., person or software module) can verify the modified HTML template documents as discussed in relation to FIG. 2 to determine whether any of the web page authors altered the HTML template document with unauthorized or unacceptable content. For example, a web site administrator can use a software program configured to verify digital documents as described above. The software application can optionally provide error logs or indications to identify errors in format, placement, and/or syntax of, for example, attributes or section identifiers in the digital document. If the modified documents cannot be verified, the web site administrator can refuse to post (or a web site administration software application can inhibit posting of) the unverified modified documents (i.e., web pages) on the web site. The modified HTML template documents that are verified are posted to the web site. In some embodiments, unverified portions can be replaced or overwritten with default or other values that are (or can be) verified or validated.

This allows a web site administrator to supervise many third party web page authors with a minimal effort. Additionally, it allows users or visitors of the web site to trust web pages developed by third party web page authors based on trust in the web site administrator. Additionally, because the web browsers operated by visitors of the web site also verify the web pages—as discussed below—visitors of the web site can have a high level of confidence that the web pages have not been altered on the computer server hosting the web site and/or during transport to the web browser.

Individuals can navigate to the web site to view the modified HTML template documents as web pages using a web browser running on a computer terminal. The computer server hosting the web page sends the web page to the web browser and the web browser attempts to verify the modified HTML document. The web browser or other software such as, for example, a web browser plug-in or other software interprets the tags in the document to determine which portion of the document includes the signature and which portions of the document are included in the signature. Additionally, the web browser decrypts the signature. The portions of the document not included in the signing—signature portion, unsigned portions, and pre-signed portions—are removed from the document and a signature is generated by the web browser using the same algorithm used to generate the signature read from the modified HTML document.

The signature of the received document generated by the web browser is validated by comparing it with the decrypted signature read from the modified HTML document. If the two signatures do not match, the signed portion of the document is not verified and the web browser indicates to the user by, for example, providing a message (e.g., an error signal) to the user in a web browser window that the modified HTML document was not verified. In some embodiments, the web browser can allow the user to indicate, for example, by clicking on a button in a web browser window a preference to retrieve another copy of the modified HTML document from another source or to display the unverified web page. In other embodiments, the web browser can automatically attempt to retrieve another copy of the modified HTML document from another source based on a stored user preference, setting or default action. In some embodiments, the web browser can generate a log entry of the failed verification or report the failed verification over a network.

If the two signatures match (e.g., are identical or within a predetermined or specified tolerance), the signed portion of the document is verified and the web browser proceeds to check the portions of the document with associated attributes to determine whether the data in those portions of the document possess the attributes associated with the portions of the document. For example, an unsigned portion of the modified HTML document can include a text string as a data set. An associated attribute can be a regular expression (“REGEX”) or other form of pattern matching that defines acceptable text patterns for the data set in the unsigned portion. The web browser can apply the REGEX to the text string to determine whether the test string has the specified attribute or property.

If the text string satisfies the REGEX, the web browser displays the web page to the user. In some embodiments, the web browser checks multiple portions of the modified HTML document for specified associated attributes. In some embodiments, the web browser indicates to the user using, for example, web browser windows, notification areas in the web browser, aural notifications and/or pop-up windows, that some or all portions of the modified HTML document possessed the attributes specified in the document. Additionally, if the modified HTML document includes any pre-signed portions, those portions can be verified based on the signatures, section identifiers and/or attributes included in the pre-signed portions, and/or other verification processes.

If the text string does not satisfy the REGEX, the web browser can indicate to the user that a portion of the document does not have a specified attribute. In some embodiments, the web browser can display alternate content specified in the document if a portion of the document does not have the specified attribute. For example, a default image can be displayed if an image does not have a specified attribute such as a maximum resolution or an approved source. In other words, a default data set (e.g., image or textual data) can be an error signal. In some embodiments, the web browser can display a message to the user in place of the portion of the web page that did not have a specified attribute. For example, a paragraph section in a web page can be replace with a message to a user indicating that text or some other data in the paragraph section did not have a specified or required attribute.

In some embodiments, a user can direct a mouse cursor over a portion of a web page displayed in a web browser containing data that did not have a specified attribute to view the data. For example, a user can place a mouse cursor over a default image to view the image that did not have the specified attribute. In some embodiments, the user can click on the default image to view the image that does not have a specified attribute. In some embodiments, portions lacking specified attributes are logged and/or reported. For example, a report can be sent to the computer server that sent the modified HTML document to the web browser indicating the portion of the document lacking an attribute.

In some embodiments, the content that fails to meet the requirements of the attributes can be highlighted by, for example, an altered background and/or foreground colors and/or an animated or static border placed around the content. In some embodiments, a web browser or other application may disable links or references found in a section that does not meet the requirements of the attribute and/or take other actions related to those links or references such as logging. In some embodiments, a background image can be placed behind data that does not meet the requirements of an associated attribute. In some embodiments, a foreground image can be placed over data failing to satisfy an attribute to protect users from clicking on or selecting a potentially malicious link.

In some embodiments, a binary file is a digital document. Some digital documents such as, for example, binary files have a specified or required format and may necessitate specialized signing and verification processes. For example, signing the binary file can include inserting a placeholder or default value or string into the binary file before generating a digital signature for the binary file to provide a portion of the binary file for a digital signature and/or other data. After the digital signature has been generated and optionally encrypted, the placeholder can be replaced with the digital signature.

Similarly, verifying the binary file can include removing the digital signature from the binary file and inserting the placeholder or default value or string into the binary file before generating a digital signature for validation. After the digital signature is validated, the digital signature removed earlier can optionally be inserted back into the binary file.

Attributes associated with a portion of a binary file can include, for example, a number of bytes or words, limitations on code or program instructions contained in the portion of the binary file, and limitations on the allowed values of bytes or words included in a data set within the portion of the binary file. Such limitations can prevent, for example, the execution of specific processor functions and/or the execution of functions with certain arguments. Such embodiments or limitations can also be applicable for script files.

In some embodiments, one or more software modules can be configured to monitor digital documents on a computer server. Such software modules can be configured to read digital documents stored on a computer server and verify the digital documents as discussed above. In some embodiments, software modules are configurable to report or notify a user such as, for example, a network administrator via email or a simple network management protocol (“SNMP”) trap when a digital document fails verification. In some embodiments, such software modules can be configured to remove, replace and/or disable digital documents that fail verification.

In some embodiments, a document editor and/or integrated development environment (“IDE”) can include instructions and/or functions to produce digital documents for signing, to sign digital documents, and/or to verify digital documents. For example, an IDE can include functionalities for including section identifiers or tags as discussed above in HTML documents, extensible markup language (“XML”) documents, and/or other digital documents for use on a web site. Additionally, the IDE can include options for signing a digital document and verifying a signed digital document. Such options or functionalities allow, for example, testing of digital documents before the digital documents are released for general distribution and use. In some embodiments, an IDE can allow highlighting of a section to define attributes or to compartmentalize in into a pre-signed object or portion of a document.

Additionally, an IDE can acquire and validate certificates for encrypting and/or generating digital signatures; provide tools for defining and/or testing regular expressions or other specified attributes; and provide shortcuts, hotkeys, mappings and/or translation tables for section identifiers or tags and standard attributes (e.g., REGEXs for dates and/or commonly forbidden words). Some IDEs can provide templates, such as signed templates, for example, that users can customize to speed the development process for digital documents. In some embodiments, an IDE can provide for simple or automatic addition of commonly used attributes such as, for example, REGEXs associated with date formats and exclusion and/or inclusion of predefined sets of words.

In some embodiments, a software module can re-sign digital documents. For example, an IDE can be configured to re-sign a digital document after one or more attributes or other signed portion or portions of a digital document have been altered within the digital document. In some embodiments, such a software module signs a digital document with a new or different key or certificate when re-signing digital documents. In some embodiments, such as digital documents having multiple signatures and signed portions, only a portion of a digital document is re-signed. In some embodiments, a software module configured to re-sign digital documents can be configured to operate in a batch mode to resign multiple digital documents in a single execution cycle.

In some embodiments, a software compiler can be configured to insert placeholders, remove placeholders and/or generate signatures for signing and verifying digital documents. This can allow, for example, a binary file to be generated or compiled, signed and verified as part of the compilation process to simplify the development process. In some embodiments, the place holders can be created by adding a variable or static value to the source code to contain the placeholder content or a meta-value that the compiler or linker will know to replace with a predefined placeholder or post-compilation signature. In some embodiments, placeholders can also contain some form of label and/or value to indicate information about the placeholder such as size and value or values with which the placeholder is to be replaced prior to verification.

In some embodiments, a digital document can include an identifier associated with the party or entity signing the digital document in a signed portion of a digital document. After or during the verification process, the identifier can be used to confirm, for example, that the document was provided by the signing entity or an entity associated with the signing entity.

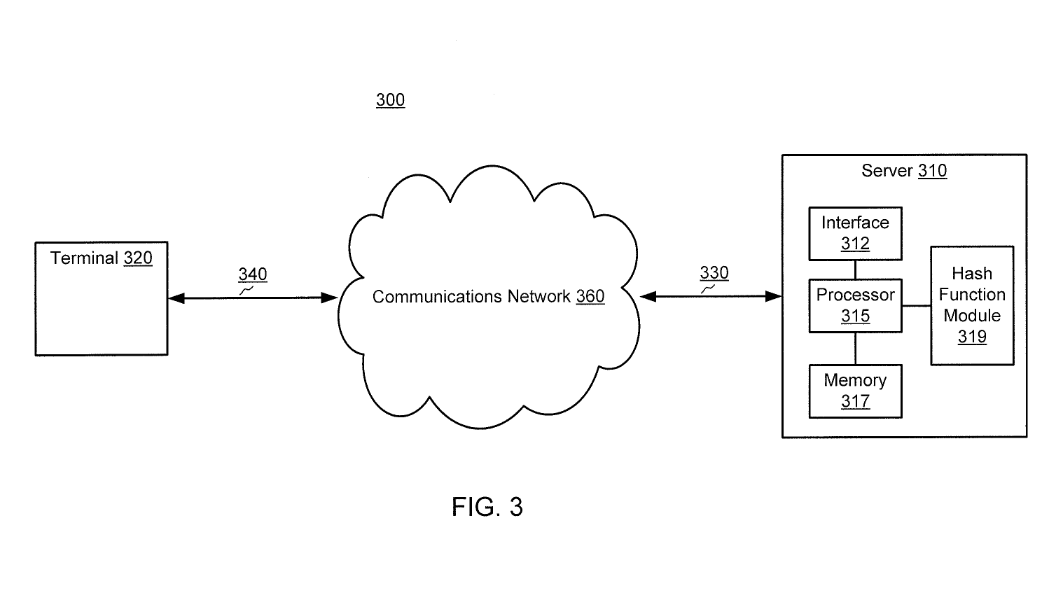

FIG. 3 is a system block diagram of system 300 for sending and receiving a signed digital document, according to an embodiment. System 300 includes server 310 configured to send digital documents to terminal 320 via communications network 360. Server 310 can be any device configurable to receive requests for digital documents from and/or send or provide access to digital documents to terminal 320. For example, a server can be a web server, a file server, a network attached storage device (“NAS”), a storage area network device (“SAN”), a database server, or a multimedia server. Terminal 320 can be any device configurable to request and/or receive digital documents from server 310. For example, terminal 320 can be a personal computer running a web browsing application, a file transfer application, a database application, and/or a multimedia application.

Communications network 360 can be any communications network configurable to allow server 310 and terminal 320 to communicate with communications network 360 and/or to each other through communications network 360. Communications network 360 can be any network or combination of networks capable of transmitting information (e.g., data and/or signals) and include, for example, a telephone network, an Ethernet network, a fiber-optic network, a wireless network, and/or a cellular network.

In some embodiments, communications network 360 can include multiple networks operatively coupled one to another by, for example, network bridges, routers, switches and/or gateways. For example, terminal 320 can be operatively coupled to a cellular network and server 310 can be operatively coupled to a fiber-optic network. The cellular network and fiber-optic network can each be operatively coupled one to another via one or more network bridges, routers, switches, and/or gateways such that the cellular network, the Ethernet network and the fiber-optic network are operatively coupled to form a communications network. Alternatively, the cellular network and fiber-optic network can each be operatively coupled one to another via one or more additional networks. For example, the cellular network and the fiber-optic network can each be operatively coupled to the Internet such that the cellular network, the fiber-optic network and the Internet are operatively coupled to form a communications network.

As illustrated in FIG. 3, server 310 is operatively coupled to communications network 360 via network connection 330, and terminal 320 is operatively coupled to communications network 360 via network connection 340. Network connections 330 and 340 can be any appropriate network connection for operatively coupling server 330 and terminal 340 to communications network 360.

In some embodiments, a network connection can be a wireless network connection such as, for example, a wireless fidelity (“Wi-Fi”) or wireless local area network (“WLAN”) connection, a wireless wide area network (“WWAN”) connection, and/or a cellular connection. In some embodiments, a network connection can be a cable connection such as, for example, an Ethernet connection, a digital subscription line (“DSL”) connection, a broadband coaxial connection, and/or a fiber-optic connection.

In some embodiments, a system can include more than one terminal and/or more than one server such a terminal can receive digital documents from more than one server and a server can send digital documents to more than one terminal. In some embodiments, a first terminal, a second terminal and/or server can be operatively coupled to a communications network by heterogeneous network connections. For example, a terminal can be operatively coupled to the communications network by a WWAN network connection, another terminal can be operatively coupled to the communications network by a DSL network connection, and a server can be operatively coupled to the communications network by a fiber-optic network connection.

Server 310 includes processor 315, interface 312 and memory 317. Server 310 is operatively coupled to communications network 360 via interface 312 and network connection 330. Interface 312 can be any interface configurable to be operatively coupled to communications network 360 via network connection 330. For example, an interface can be a wireless interface such as, for example, a worldwide interoperability for microwave access (“WiMAX”) interface, a high-speed packet access (“HSPA”) interface, and/or a WLAN interface. An interface can also be, for example, an Ethernet interface, a broadband interface, a fiber-optic interface, and/or a telephony interface.

Processor 315 is operatively coupled to interface 312 such that processor 315 can be configured to be in communication with communications network 360 via interface 312. Processor 315 can be any of a variety of processors. Such processors can be implemented, for example, as hardware modules such as embedded microprocessors, microprocessors as part of a computer system, Application-Specific Integrated Circuits (“ASICs”), and Programmable Logic Devices (“PLDs”). Some such processors can have multiple instruction executing units or cores. Such processors can also be implemented as one or more software modules in programming languages as Java™, C++, C, assembly, a hardware description language, or any other suitable programming language. A processor according to some embodiments includes media and computer code (also can be referred to as code) specially designed and constructed for the specific purpose or purposes.

In some embodiments, a server can be a virtual device implemented in software such as, for example, a virtual machine executing on or in a processor. For example, a server can be a software module executing in a virtual machine environment such as, for example, a Java™ module executing in a Java™ Virtual Machine (“JVM”), or an operating system executing in a VMware™ virtual machine. In some such embodiments, a network interface, a processor, and a memory can be virtualized and implemented in software executing in, or as part of, a virtual machine.

Processor 312 is also operatively coupled to memory 317. Memory 317 can be a read-only memory (“ROM”); a random-access memory (“RAM”) such as, for example, a magnetic disk drive, and/or solid-state RAM such as static RAM (“SRAM”) or dynamic RAM (“DRAM”); and/or FLASH memory or a solid-data disk (“SSD”). In some embodiments, a memory can be a combination of memories. For example, a memory can include a DRAM cache coupled to a magnetic disk drive and an SSD.

In addition to memory 317, some embodiments include another processor-readable medium, for example a database accessible to server 310, (not shown in FIG. 3) having instructions or computer code thereon for performing various processor-implemented operations including, for example, signing and verifying digital documents. Examples of processor-readable media include, but are not limited to: magnetic storage media such as hard disks, floppy disks, and magnetic tape; optical storage media such as Compact Disc/Digital Video Discs (“CD/DVDs”), Compact Disc-Read Only Memories (“CD-ROMs”), and holographic devices; magneto-optical storage media such as floptical disks; solid-state memory such as SSDs and FLASH memory; and ROM and RAM devices. Examples of computer code include, but are not limited to, micro-code or micro-instructions, machine instructions (such as produced by a compiler), and files containing higher-level instructions that are executed by a computer using an interpreter. For example, an embodiment may be implemented using Java™, C++, or other object-oriented programming language and development tools. Additional examples of computer code include, but are not limited to, control signals, encrypted code, and compressed code.

In some embodiments, as illustrated in FIG. 3, server 310 (and/or terminal 320) can include hash function module 319. Hash function module 319 is configured to generate or define a hash value (or some other digital signature) based on one or more input digital documents (or other data sets) stored at a memory such as memory 317, Hash function module 319 can be a hardware module such as, for example, a processor configured to execution instructions or commands stored at a memory, an ASIC, or an FPGA. In some embodiments, hash function module 319 can be a software module configured to execute at processor 315.

In some embodiments, terminal 320 also includes an interface, a processor and a memory. For example, a personal computer terminal and a portable or handheld device, such as a cellular telephone device or portable/mobile internet device, can include an interface, a processor and a memory.

Server 310 is configured to provide digital documents that have been previously signed as described above to terminal 320 via network 360. For example, digital documents stored on memory 317 or in a database accessible to server 310. In some embodiments, server 310 verifies the digital documents in real time or on-demand (e.g., server 310 verifies or validates the digital documents after receiving a request for the digital document) before providing the digital documents to terminal 320. For example, the digital documents can be verified as described above. In some embodiments, terminal 310 also verifies the digital documents after receiving them from server 310. For example, a terminal can verify a digital document to confirm that the digital document was not altered during transport over an unknown or unsecured communications network, and/or a terminal can verify a digital document sent by an unknown or unauthenticated server to confirm that the digital document was not altered after it was signed. In some embodiments, terminal 310 does not verify the digital documents after receiving them from server 310. For example, a terminal can trust that digital documents sent from a known or authenticated server and/or digital documents that have been transported over a secure network have not been altered.

In some embodiments, a server can notify a terminal of the verification status of a digital document. For example, a server can send data to a terminal indicating that a digital document was successfully verified prior to the server sending the digital document to the terminal, that a digital document failed verification prior to the server sending the digital document to the terminal, or that the server did not attempt to verify the digital document prior to the server sending the digital document to the terminal. In some embodiments, a server can provide alterative content to a terminal if a digital document fails verification. For example, a server can provide alternative content specified in the digital document and/or other alternative content. In some embodiments, a server can notify a terminal that alternative content has been or will be provided.

In some embodiments, a terminal can send data to a server including a request for the server to either attempt to verify or not attempt to verify a digital document prior to the server providing the digital document to the server. For example, a terminal in communication with an authenticated server via a secured network connection can request that the server verify the digital documents and the terminal will not verify the digital documents.

In some embodiments, a server signs digital documents as described above before sending digital documents to a terminal. Thus, digital documents located in a memory attached or accessible to a server can be unsigned, and the server signs the documents prior to sending the digital documents to a terminal.

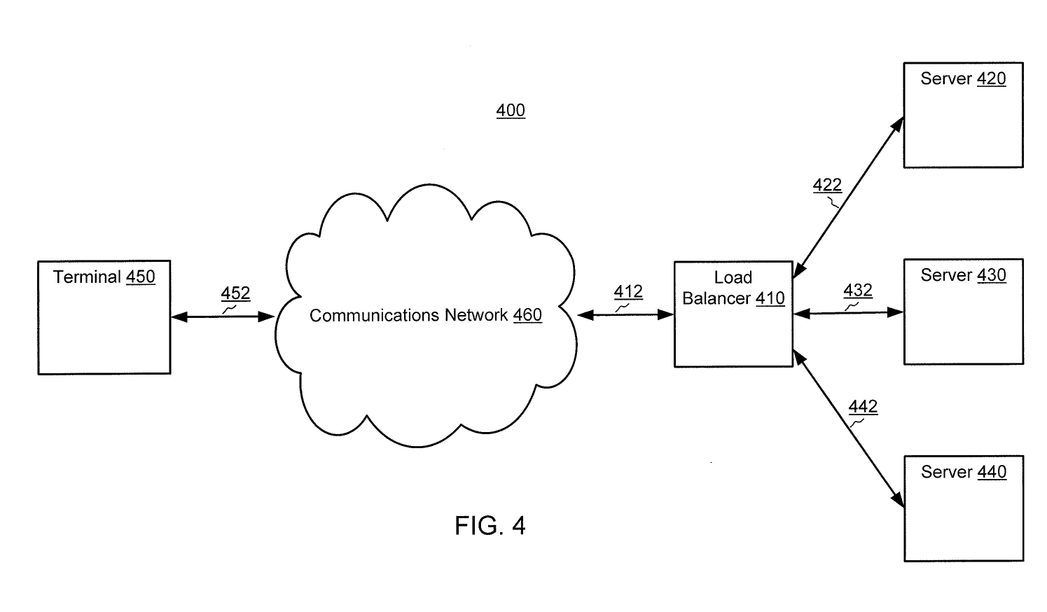

FIG. 4 is a system block diagram of system 400 for sending and receiving a signed digital document, according to another embodiment. System 400 is configured to allow terminal 450 to access one or more of servers 420, 430 and 440 via communications network 460 and load balancer 410. Load balancer 410 is any device configured to function as an intermediary between terminal 450 and servers 420, 430 and 440.

Communications network 460 can be any network configured to allow terminal 450 to communication with load balancer 410. Terminal 450 is operatively coupled to communications network 460 via network connection 452. Load balancer 410 is operatively coupled to communications network 460 via network connection 412. Servers 420, 430 and 440 are operatively coupled to load balancer 410 via connections 422, 432 and 442, respectively. In some embodiments, servers can be operatively coupled to a load balancer via a communications network.

Load balancer 410 is configured to verify digital documents as described above. In the configuration illustrated in FIG. 4, load balancer 410 received digital documents from servers 422, 432 and 442 and verifies digital documents before providing them to terminal 450, and servers 422, 432 and 442 do not verify digital documents. This configuration can shift operational processing associated with verifying digital documents from servers 422, 432 and 442 to load balancer 410, or can provide an additional layer of verification. In some embodiments, a load balancer includes specialized hardware and/or software for verifying digital documents. For example, a load balancer can include accelerator hardware such as, for example, accelerator cards and/or chips configured to rapidly and efficiently execute one or more processes for verifying digital documents. Optionally, the load balancer can receive messages from servers stating whether or not the documents were successfully verified prior to the servers providing the content.

In some embodiments, a load balancer can notify an administer or a user that a particular server frequently provides digital documents that fail verification. For example, a load balancer can send an electronic mail message (“email”) to a network administrator including information about a server that is suspected as being compromised based on a number or frequency of digital documents that have failed verification. In some embodiments, a load balancer can black-list or grey-list servers that provide digital documents that fail verification above a predetermined threshold. In some embodiments, a load balancer can identify a possible attacker by determining that requests from a given terminal exceed a tolerance threshold for returned documents that fail to validate correctly and take appropriate actions such as notifying an administrator, sharing this information with other load balancers/servers/devices or blacklisting an identifier associated with the possible attacker such as, for example, an internet protocol (“IP”) address.

In some embodiments, a web proxy or reverse proxy can be included in place of or in addition to a load balancer. In some embodiments, a load balancer or other device is indirectly operatively coupled to a server. For example, a load balancer can be operatively coupled to a communications network and a server can be operatively coupled to the communications network such that the load balancer and server are operatively coupled via the communications network. In some embodiments, a load balancer can be operatively coupled to a communications network, a server can be operatively coupled to a communications network and these communications networks can be operatively coupled by, for example, a network bridge, gateway, router, switch, or another communications network or networks, such that the load balancer and server are operatively coupled via one or more communications networks.

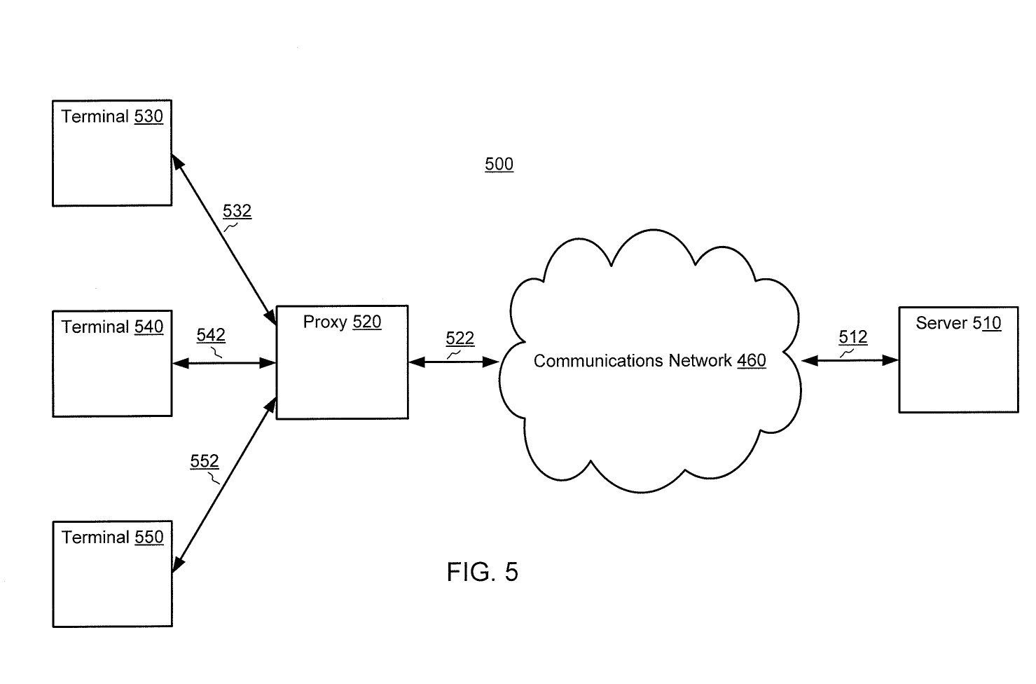

FIG. 5 is a system block diagram of system 500 for sending and receiving a signed digital document, according to another embodiment. System 500 is configured such that server 500 provides digital documents to proxy 520 via communications network 560, proxy 520 verifies digital documents, and proxy 520 provides verified digital documents to terminals 530, 540 and 550. Server 510 is operatively coupled to communications network 560 via network connection 512. Proxy 520 is operatively coupled to communications network 560 via network connection 522. Terminals 530, 540 and 550 are operatively coupled to proxy 520 via connections 532, 542 and 552, respectively. In some embodiments, terminals can be indirectly operatively coupled to a proxy via, for example, a communications network or networks as discussed in relation to FIG. 4.

In the configuration illustrated in FIG. 5, proxy 520 verifies digital documents and sends the digital documents to terminal 530, 540 and 550, and terminal 530, 540 and 550 do not verify digital documents. For example, proxy 520 can be located behind a firewall within a corporate intranet and operatively coupled to terminals 530, 540 and 550 via the corporate intranet. Proxy 520 can verify digital documents to shift operational processing associated with verification of digital documents from terminals 530, 540 and 550 to proxy 520. In some embodiments, a proxy includes specialized hardware and/or software for verifying digital documents. In some embodiments, terminals verify digital documents after receiving them from a proxy.

In some embodiments, a terminal can request that a proxy verify or not verify digital documents before sending or forwarding them to the terminal. In some embodiments, a proxy can notify a user of terminal and/or another user such as, for example, a network administrator that a digital document failed verification. In other words, the proxy can send an error signal if a digital document fails verification. For example, a proxy can notify a user with an email, an instant message (“IM”), a text message, and/or a voice message.

In some embodiments, a proxy can provide default or alternative content for content in a digital document that fails verification. Alternate content can be specified, for example, in the digital document and/or a network or proxy policy. In some embodiments, a proxy can notify a user of a terminal receiving default or alternate content that the user is receiving default or alternate content. For example, a proxy can add text to an HTML digital document to be displayed as a web page in a web browser running on a terminal indicating that a portion of the web page described by the HTML document includes default content because that portion of the HTML document failed verification. In some embodiments, a proxy can black-list or grey-list servers that provide digital documents that fail verification above a predetermined threshold. Such a threshold can be, for example, percentage, a frequency and/or a count of digital documents that have failed verification. In some embodiments, a proxy can determine that a given user or IP address sends an unusual volume of requests that result in documents which fail to validate correctly, and take action such as blocking the user or IP address, notifying administrators, or sharing this information with other devices and/or proxies.

While certain embodiments have been shown and described above, various changes in form and details may be made. For example, some features of embodiments that have been described in relation to one embodiment and/or process for signing and/or verifying a digital document can be useful in other embodiments and/or processes. Additionally, embodiments described with reference to specific or particular cryptographic techniques such as public/private key encryption or digital certificates can be useful with other cryptographic or security techniques. Some embodiments that have been described in relation to a software implementation can be implemented as digital or analog hardware. For example, a server, personal computer or other terminal can include specialized hardware such as one or more accelerator cards and/or chips for signing and/or verifying a digital document.

Furthermore, it should be understood that the systems and methods described herein can include various combinations and/or sub-combinations of the components and/or features of the different embodiments described. For example, steps or methods described in relation to one embodiment of signing or verifying a digital document can be combined with steps or methods described in relation to other embodiments of signing or verifying a digital document. Additionally, steps described in relation to verifying a digital document can be applicable to signing a digital document; and steps described in relation to signing a digital document can be applicable to verifying a digital document. Furthermore, in some embodiments, a digital document can include multiple digital documents, each with one or more sections or portions and one or more digital signatures. Thus, features described with reference to one or more embodiments can be combined with other embodiments described herein.

What is claimed is:

1. A method, comprising:
associating a description of an attribute of a data set with a digital document stored at a memory, the data set capable of being included in the digital document; and
generating a digital signature based on the digital document, the generating including the description of the attribute, the generating not including the data set.

2. The method of claim 1, wherein the data set includes a textual string.

3. The method of claim 1, wherein the attribute includes a pattern.

4. The method of claim 1, wherein the attribute includes at least one of a minimum file size or a maximum file size.

5. The method of claim 1, wherein the attribute includes a file type identifier.

6. The method of claim 1, further comprising:
storing the digital signature at the memory such that the digital signature is associated with the digital document.

7. The method of claim 1, further comprising:
sending the digital document, the description of the attribute, the data set, and the digital signature to a client device via a communications network.

8. The method of claim 1, wherein:
the digital signature is a hash value; and
the generating includes providing the digital document and the description of the attribute to a hash function module configured to output the digital signature.

9. A method, comprising:
generating a digital signature based on a digital document stored at a memory, the digital document including data associated with an attribute potentially possessed by a data set, the generating including the data associated with the attribute, the generating not including the data set;
validating the digital signature; and
determining whether the data set possesses the attribute.

10. The method of claim 9, further comprising:
removing the data set from the digital document before the generating.

11. The method of claim 9, wherein the data set does not possess the attribute, the method further comprising:
discarding the data set in response to the determining.

12. The method of claim 9, wherein the data set does not possess the attribute, the method further comprising:
sending an error signal to via a communications network in response to the determining.

13. The method of claim 9, wherein the validating includes comparing the digital signature with a portion of the digital document.

14. The method of claim 9, further comprising:
receiving, at a first time, the digital document via communications network; and
receiving, at a second time after the first time, the data set via the communications network.

15. The method of claim 9, wherein the data set possesses the attribute, the method further comprising:
receiving, before the generating, a request for the digital document via a communications network; and
sending, after the determining, the digital document via the communications network.

16. One or more processor-readable media storing code representing instructions that when executed by one or more processors cause the one or more processors to:
generate a digital signature based on a digital document stored at a memory;
access a description of an attribute within the digital document, the attribute associated with a data set capable of being included in the digital document; and
determine whether the data set possesses the attribute.

17. The one or more processor-readable media of claim 16, further storing code representing instructions that when executed by the one or more processor cause the one or more processors to:
display a representation of the data set if the data set possesses the attribute; and
display a representation of an error signal if the data set does not possess the attribute.

18. The one or more processor-readable media of claim 16, wherein the data set is included in the digital document and the data set does not possess the attribute, the one or more processor-readable media further storing code representing instructions that when executed by the one or more processor cause the one or more processors to:
replace the data set with a default data set such that the default data set is included in the digital document; and
sending the digital document via a communications network.

19. The one or more processor-readable media of claim 16, further storing code representing instructions that when executed by the one or more processor cause the one or more processors to:
determine that a portion of the digital document is excludable from the digital signature; and
exclude the portion of the digital document from the digital signature such that the digital signature is generated exclusive of the portion of the digital document.

20. The one or more processor-readable media of claim 16, further storing code representing instructions that when executed by the one or more processor cause the one or more processors to:
verify the digital signature based on a portion of the digital document including a previously-generated digital signature.
